(19) United States
(12) Patent Application Publication
(10) Pub. No.: US 2008/0259463 A1
(43) Pub. Date: Oct. 23, 2008

(54) Variable Focal Length Lens

(75) Inventor: Mark Richard Shepherd, Royston (GB)

Correspondence Address: NIXON & VANDERHYE, PC, 901 NORTH GLEBE ROAD, 11TH FLOOR, ARLINGTON, VA, 22203, US

(73) Assignee: 1...LIMITED, Cambridge (GB)

(21) Appl. No.: 11/547,512

(22) PCT Filed: Apr. 1, 2005
(86) PCT No.: PCT/GB05/01274

§ 371 Date: Dec. 15, 2006

(30) Foreign Application Priority Data
Apr. 1, 2004 (GB) 0407414.2

(51) Int. Cl. G02B 3/14

(52) U.S. Cl. 359/666

(57) ABSTRACT

A variable focal length lens, comprises a chamber arrangement containing two transparent liquids adjacent one another with an interface therebetween, the chamber arrangement allowing light to pass along an optical axis through the transparent liquids and across the interface, the lens focusing the passing light. A piezoelectric actuator is arranged, on activation, to change the pressure of one of the liquids so that the interface moves, for example by changing shape, to change the focal length of the lens.

The invention relates to a lens having variable focal length. Such a lens is suitable for use in an optical imaging apparatus such as a digital camera.

A camera typically has a lens arrangement of one or more lenses which serve to bring light to a focus on an image plane. Typically, the lens arrangement has a characteristic focal length which allows images of objects at a given range of distances from the camera to be brought to focus on the image plane. Images of objects outside this range of distances cannot be brought to focus unless the optical power of the lens arrangement is changed, or the lens to image plane distance is changed.

In most commercially available cameras, the focal length of the lens arrangement is changed by moving one or more of the lenses. Typically, in modern cameras, movement of the lens is brought about by an electrically driven motor or actuator. Such motor and actuator mechanisms contain moving parts and are relatively complex, introducing issues of reliability, cost, size and weight. Also, they consume relatively high amounts of power on actuation, which is an issue in battery powered devices. These issues are particularly important in cameras in portable electronic devices such as dedicated digital cameras and in multi-purpose devices incorporating miniature cameras, such as mobile phones.

As an alternative to physically moving a lens, there have been proposed a first type of lens arrangement in which the focal length is variable by physically changing the external shape of a deformable lens element made of transparent elastomeric material or as a fluid filled balloon. Examples of the latter are disclosed in U.S. Pat. No. 6,493,151, in which the shape of a liquid lens is changed by mechanically causing the equatorial diameter to expand radially, and in U.S. Pat. No. 6,344,930, in which one part of a two-part elastomeric fluid-filled envelope is stretched by stacks of piezoelectric actuators. This type of lens arrangement generally suffers the drawback that the liquid inside the envelope of the lens is affected by gravity, causing non-symmetrical bulging of the lens when the lens is vertical (ie the optical axis is horizontal), which is usually the case in photography. Such lenses are difficult to apply in high resolution cameras. In addition, the mechanical or electromechanical devices used to cause the lens to change shape are relatively complex and power hungry.

A second type of variable focal length lens arrangement has been proposed in which the above-described problems of gravity is overcome, for example as disclosed in U.S. Pat. No. 6,369,954. In this type of lens arrangement, two liquids of equal density but differing refractive index are contained in a chamber. By a process known as electro-wetting, application of an electric field changes the contact angle of one of the liquids with a bounding surface, thereby changing the curvature of the interface between the liquids and hence the focal length of the lens. One drawback of this and similar devices is an unwanted variation in the shape of the interface with temperature, due to temperature sensitivity of material properties such as density, surface tension and the electro-wetting effect. Other drawbacks include the tendency of the liquids to mix when vigorously agitated (e.g. shaken) and deformation of the interface due to inertial effects.

It would be desirable to provide a variable focal length lens which overcomes at least some of these drawbacks in the known types of lens arrangement.

According to the present invention, there is provided a variable focal length lens, comprising:

a chamber arrangement containing two transparent liquids adjacent one another with an interface therebetween, the chamber arrangement allowing light to pass along an optical axis through the transparent liquids and across the interface, the lens focusing the passing light;

a piezoelectric actuator arranged, on activation, to change the pressure of one of the liquids so that the interface moves to change the focal length of the lens.

The movement of the interface between the two liquids allows variation of the focal length of the lens. The use of two liquids minimizes deformation of the lens due to gravity in a similar manner to the second known type of lens arrangement described above, for example by using liquids of similar density. Therefore the liquids desirably have substantially the same density such that the shape of the interface is not affected by gravity when the lens is held with the optical axis extending horizontally. However, in contrast to the second known type of lens arrangement, the problems of temperature sensitivities are less severe and can be readily overcome by compensating action of the piezoelectric actuator.

In one type of embodiment, the liquids have a differing refractive index and the piezoelectric actuator is arranged, on activation, to change the pressure of one of the liquids so that the interface changes shape to change the focal length of the lens. In this case, the difference in refractive index allows the liquids to act as a lens. The shape of the interface between the liquids is caused to change by change of the pressure of one of the liquids by a piezoelectric actuator.

The liquids are separated by an interface, which may simply be the interface between immiscible liquids which touch one another. However, this arrangement suffers some of the drawbacks noted above with regard to the second known type of lens arrangement. Preferably, however, a transparent elastomeric membrane is provided at the interface between the liquids. This is deformable to allow the required change in the shape of the interface, but has further advantages. Firstly elastomeric membrane prevents mixing of the liquids and maintains a stable interface between them. Secondly, the elastomeric membrane resists the effect of gravity on the two liquids. This makes it possible to use liquids with less similar densities than would otherwise be possible, thereby increasing the choice of possible materials.

In another type of embodiment, a rigid transparent element is provided at the interface between the liquids, the piezoelectric actuator is arranged, on activation, to change the pressure of one of the liquids so that the rigid transparent element at the interface moves by being displaced to change the focal length of the lens. In this case, there is no change of shape of the interface, but change in the focal length is nonetheless achieved by the displacement of the rigid element, for example by the liquids having differing refractive indices or by the rigid element being itself a lens. As compared to the type of embodiment in which the shape of the interface changes, this type of embodiment generally allows a smaller change in the focal length but allows the use of a rigid element of high optical quality which is advantageous in some situations.

The two liquids are disposed axially along the desired optical axis along which the chamber arrangement allows light to pass. Thus, in operation, light passes first through the first liquid, across the interface and then through the second liquid. The liquids are conveniently contained in chambers arranged sequentially along the optical axis.

Either or both of the chambers may include a circumferential chamber wall extending around the optical axis made wholly or in part of a deformable elastic material, thereby allowing sideways (radial) movement of the walls and the liquids contained within them. The outer end of each liquid chamber may be sealed with a rigid transparent plate. The plate may be flat and parallel sided, or one or both of its surfaces may be curved to form a lens. The material of the end plates may be glass or plastic.

The piezoelectric actuator may act on the deformable elastic material of the circumferential chamber wall of a liquid chamber. To obtain maximum effect, the chamber wall is made of a deformable elastic material around its entire circumference and the piezoelectric actuator extends around substantially the entirety of the deformable elastic material, except for any gaps needed to allow movement of the actuator on actuation. An advantageous and compact form of actuator is in the form of a section of a cylinder, such that its cross-section is approximately in the form of a letter C, and with a construction of a piezoelectric bender. The bending of such an actuator results in radial expansion or contraction, together with some circumferential displacement of the free ends. Such actuators are described for example in the co-owned international patent application published under the number WO-03/001841 (in particular in the embodiments of FIGS. 9 and 10) which is incorporated herein by reference. However, other forms of actuator are possible, for example an actuator extending in a helix around the chamber wall, or an actuator acting on a single part of the chamber wall.

The actuator is made of a piezoelectric material, preferably a piezoelectric ceramic and more preferably of the piezoelectric ceramic known as PZT (lead zirconate titanate).

In a first embodiment of the invention, a single actuator is provided to act on a first one of the liquids. In operation, the actuator changes the pressure of the first liquid, typically by applying a radially inward force pressurizing the liquid or a radially outward force depressurizing the liquid. As a result, the interface between the two liquids is forced to change shape by bulging towards or away from the second liquid. Preferably, some means of pressure relief for the second liquid is provided, to allow redistribution of the liquid in the second chamber and full movement of the interface. The pressure relief means is preferably a deformable material in the circumferential chamber wall. In a similar manner, the actuator may act to move the first chamber wall outward rather than inward.

In a second embodiment, a second actuator is provided to act on the second liquid, in addition to the first actuator acting on the first liquid. The two actuators are operable in tandem, such that one moves inward as the other moves outward. The volumes and pressures within the two chambers are thus readily balanced at all times.

Further liquid chambers may be provided in addition, providing lenses of greater complexity. The complex lens may comprise three, four or more such chambers. The chambers may be arranged sequentially within the same housing, acting in concert. Alternatively, pairs of chambers, each forming an independent lens, may be stacked such that they operate independently. In each case, one or more, or even all, of the chambers are provided with a piezoelectric actuator.

The variable focal length lens may also incorporate a conventional lens, that is a rigid lens element for example made of glass or plastic. By suitable selection of lenses, lens assemblies including variable focal length lenses of the invention can be made to perform focus, zoom or zoom-plus-focus functions.

The invention includes a camera incorporating a variable focal length lens as described above. The variable focal length lens is particularly advantageous when used in miniature digital cameras, as used for example in portable electronic devices such as dedicated digital cameras, mobile phones, PDAs, lap-tops and the like. The lenses in such miniature cameras are of the order of a few millimeters diameter; the diameter may be as small as 1 mm, preferably at least 2 or 3 mm, or as large as 20 mm, preferably at most 15 mm.

Non-limitative examples of the variable focal length lens of the invention are described below with reference to the accompanying drawings. In the drawings:

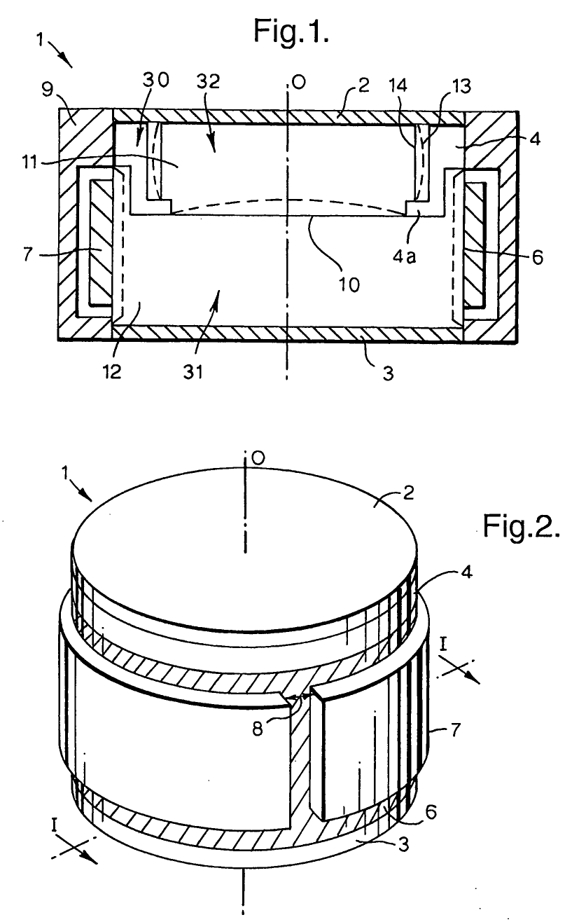

FIG. 1 is a cross-sectional view of a first variable focal length lens, the cross-section being taken parallel to the optical axis;

FIG. 2 is a perspective view of the first variable focal length lens with the housing omitted for clarity;

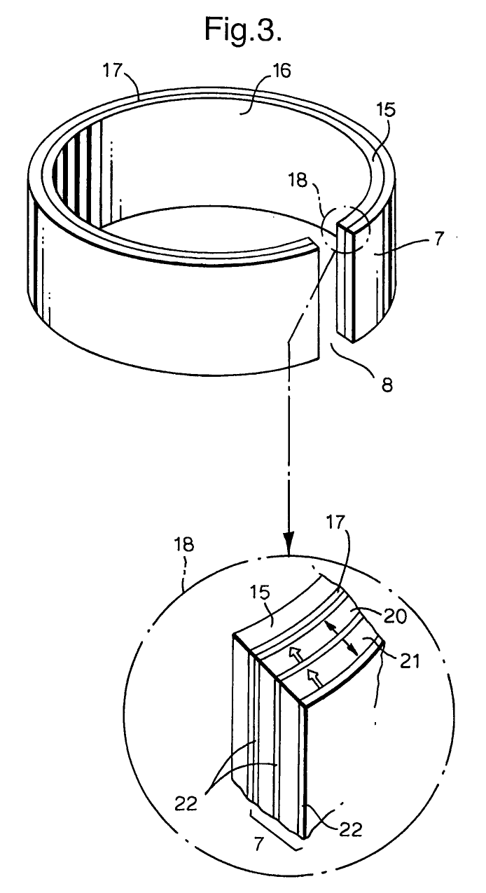

FIG. 3 is a perspective view of the variant of the piezoelectric actuator including a detailed view of the end of the actuator;

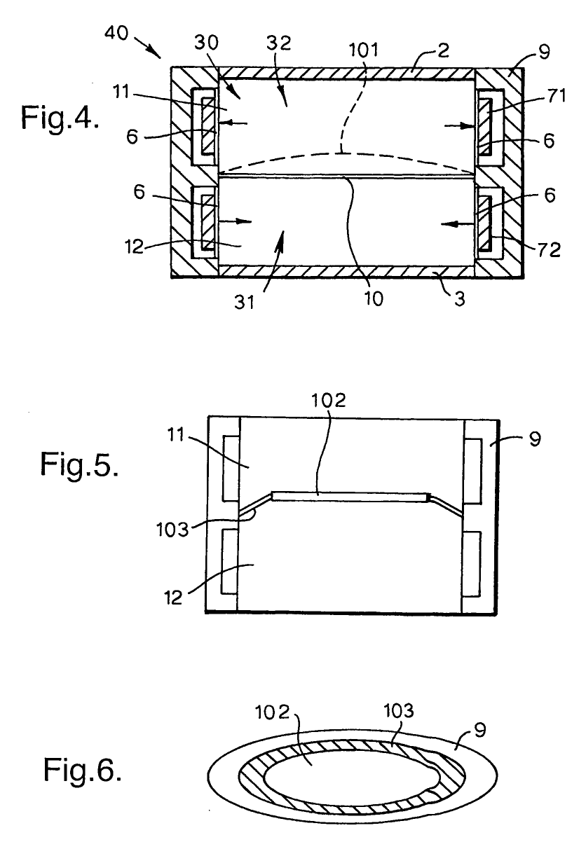

FIG. 4 is a cross-sectional view of a second variable focal length lens;

FIG. 5 is a cross-sectional view of a variant of the second variable focal length lens;

FIG. 6 is a perspective view of the plate assembly of the variant of FIG. 5;

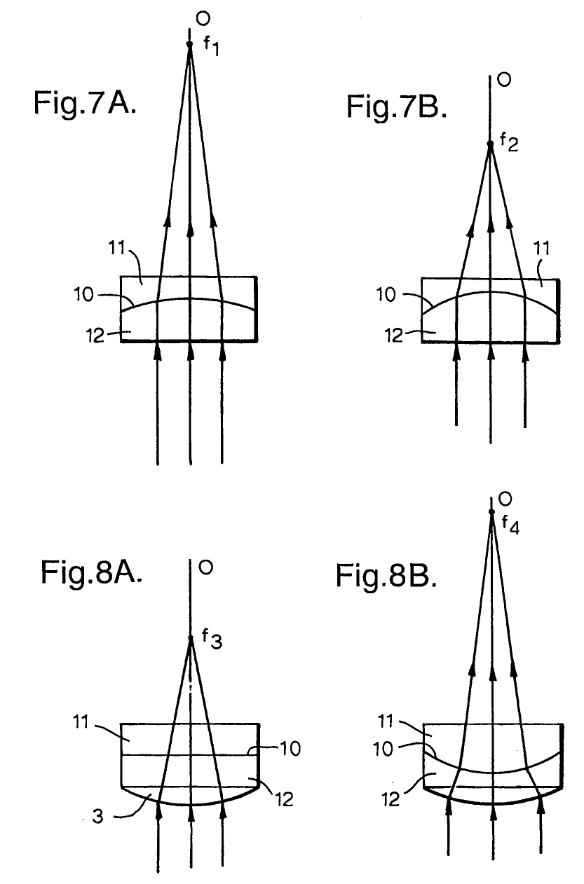

FIGS. 7A and 7B are schematic ray diagrams showing the operation of a variable focal length lens; and

FIGS. 8A and 8B are schematic ray diagrams showing the operation of a further variable focal length lens.

FIGS. 1 and 2 show a first variable focal length lens 1, the cross-section of FIG. 1 being taken parallel to the optical axis O and along the line I-I in FIG. 2.

The lens 1 comprises a chamber arrangement 30 defining two chambers 31 and 32. The first chamber 31 has an annular chamber wall 6 (shown hatched in FIG. 2) extending circumferentially around the optical axis O and made in its entirety of an elastic deformable material (or of elastic deformable material with some rigid sections). The chamber wall 6 is mounted inside an annular housing 9 which is omitted from FIG. 2 for clarity. The outer end of the first chamber 31 is capped by a transparent window 3 mounted to the housing 9.

The second chamber is spaced axially along the optical axis O and has an annular chamber wall 14 extending circumferentially around the optical axis O and made in its entirety of an elastic deformable material (or of elastic deformable material with some rigid sections). The chamber wall 14 is mounted inside an annular insert 4 itself mounted inside the housing 9. The insert 4 has an circular lip 4a on the side adjacent the first chamber 31 and protruding inwardly to define the aperture of the lens 1. The chamber wall 14 is set radially outwardly of the lip 4a but is spaced from the insert 4 to define an expansion chamber 13 therebetween. The outer end of the second chamber 32 is capped by a transparent window 2 mounted to the housing 9.

The first chamber 31 contains a first liquid 12 and the second chamber contains a second liquid 11, the liquids having an interface 10 extending inside the lip 4a. The liquids 11 and 12 may be immiscible but arranged touching one another so that the interface 10 is simply the boundary between the liquids. More preferably, the interface 10 is a transparent elastic membrane which divides the chambers 31 and 32.

The liquids 11 and 12 are of similar density so that interface is not deformed under gravity when the optical axis O is horizontal. The liquids 11 and 12 are transparent but have differing refractive index. Thus light passing along the optical axis O passes through both windows 2 and 3 and through both liquids 11 and 12 across the interface 10. The lens 1 focuses the passing light due to the bending of the light at the interface 10 caused by the differing refractive indices of the liquids 11 and 12. Where the interface 10 is a transparent elastic membrane, it preferably has a refractive index matching one of the liquids 11 and 12, although it may alternatively have a differing refractive index. In operation the interface 10 is normally curved but may be flat.

Circumscribing the chamber wall 6 of the first chamber 31 is a piezoelectric actuator 7 shaped as the section of a cylinder extending entirely around the chamber wall 6 except for a gap 8 which allows movement of the ends of the actuator 8 on actuation. The actuator 7 engages the chamber wall 6. The actuator 7 has a bender construction consisting of a plurality of layers including one layer of piezoelectric material (in a unimorph construction) or plural layers of piezoelectric material (in a bimorph or multimorph construction). An example of a bimorph bender construction is described with reference to FIG. 3 below. The actuator 7 further has electrode layers across which in operation a voltage is applied to produce a differential contraction or expansion of the layers, thereby causing the actuator 7 to bend inwardly or outwardly. The shape of the actuator 7 causes this bending to be concomitant with radial expansion or contraction which presses the chamber wall 6 inwards or releases the chamber wall 6 so that it moves outwardly due to its elasticity. Alternatively, the actuator 7 may be bonded to the chamber wall 6 so that expansion of the actuator 7 pulls the chamber wall 6 outwardly. Thus activation of the actuator 7 changes the pressure of the first liquid 11.

Dotted lines in FIG. 1 show schematically the movement of the chamber wall 6, the interface 10 and the chamber wall 14 during operation when the actuator 7 contracts. The actuator 7 causes the chamber wall 6 to move inwards, pressurizing the first liquid 12 in the first chamber 31. The interface 10 therefore bulges into the second chamber 32. The second liquid 12 in the second chamber 32 expands sideways into expansion chamber 13 by deforming the chamber wall 14, whereby the expansion chamber acts as a pressure relief means. As a result of the movement and change of shape of the interface 10 between the liquids 11 and 12, the focusing effect of the interface 10 changes and hence focal length of the lens 1 as a whole changes. That is to say light rays travelling through the lens 1 traverse different path lengths through liquids 11 and 12 in the activated state than in the unactivated state. The device therefore acts as a variable focal length lens, the focal length depending on the extent and polarity of activation of the actuator 7.

Variants of the above design are possible some examples being given below.

The windows 2 and 3 at each end of the lens 1 are shown in FIGS. 1 and 2 as parallel sided plates in which case they have no effect on the focusing of light. Alternatively, either or both of the windows 2 and 3 may be shaped as optical lenses to contribute to the focusing of light. That is, one or both surfaces of one or both windows 2 and 3 may be curved, spherically or in some other manner.

In a further variant, the expansion chamber 13 is filled with a soft deformable material such as a polymeric foam, in which case the chamber wall 14 shown in FIG. 1 is not required. The second liquid 12 expands into the expansion chamber 13 by deforming the material directly, for example by compressing the gas in the pores of a closed-cell polymeric foam. The soft deformable material in expansion chamber 13 may be formed integrally with the insert 4, for example by two-shot plastic moulding.

In a yet further variant, the piezoelectric actuator 7 may be spaced from the chamber wall 6 by a pressure transfer band 15, as shown in FIG. 3. The pressure transfer band 15 is shaped as a section of a cylinder like the actuator 7, but is of smaller diameter. The band 15 is manufactured in a material such as metal or plastic (preferably injection moulded plastic) to provide an accurately dimensioned inner surface 16. The actuator 7 is glued to the outside surface of the band 15, in such a way that the imperfections in the actuator 7 are evened out in the glue layer 17. In operation, an expansion or contraction of the actuator 7 is transmitted through the band 15 to the chamber wall 6, the band 15 serving to make the pressure uniform. The actuator 7, which is typically a bi-layer piezoelectric ceramic, may have some inevitable imperfections in circularity and inner diameter introduced during manufacture, but the band 15 compensates for these.

More detail of the construction of the actuator 7 is shown in the expanded view of the end of the actuator of FIG. 3, as denoted by the dotted circle 18. The actuator 7 is of bimorph bender construction (known per se in the art), comprising two layers 20 and 21 of piezoelectric material, preferably PZT, and three electrode layers 22. During operation, an electric field is applied across the piezoelectric layers 20 and 21 by the electrodes 22, connected to an external circuit (not shown). To operate as a bender, one layer is activated parallel to its poling direction while the other layer is activated anti-parallel to its poling direction. An example of a suitable scheme is shown in FIG. 3 where the double-stalked arrows represent the poling directions and the single-stalked arrows indicate the activation field directions. In this mode, one piezoelectric layers 20 or 21 expands and the other piezoelectric layers 20 or 21 contracts, causing bending. Such bending results in radial expansion (or contraction) and circumferential movement causing the gap 8 between the ends of the actuator to open (or close). The extent of expansion or contraction is a function of the magnitude of the electric field applied, such that the amount of radial movement of the actuator can be readily controlled by varying the applied voltage. Thus the actuator is of a bi-layer (bimorph) or multi-layer construction with the layers arranged to bend on activation. The same construction of the actuator 7 may be used without the band 15 being present, as shown in FIG. 1.

FIG. 4 shows a second variable focal length lens 40 which is the same as the first focal length lens 1 except as will now be described. Common elements are given common reference numerals and a description thereof will not be repeated. The second variable focal length lens 40 has two piezoelectric actuators 71 and 72. As before, the housing 9 is essentially cylindrical and capped at each end by transparent windows 2 and 3. Two liquid chambers 31 and 32 contain liquids 12 and 11 respectively, having an interface 10 in the form of a transparent deformable membrane. In this second variable focal length lens 40, each chamber 31 and 32 has essentially the same construction having a circumferential chamber wall 6 manufactured in elastically deformable material and is engaged by a respective one of the piezoelectric actuators 71 and 72. The two actuators 71 and 72 are caused to actuate in tandem; that is, when one is activated to expand radially, the other is activated to contract radially (as shown by the arrows in FIG. 4), and vice versa. An example of the effect is shown by the dotted line 101, which denotes the position of the interface 10 when the first actuator 72 contracts, pressurizing the first liquid 12 in the first chamber 31, while the second actuator 71 expands, depressurizing the second liquid 11 in the second chamber 32. The result is bulging of the membrane 10 into the second chamber 32, curving the interface 10 as shown by the dotted line 101. The advantage of this embodiment is the balanced design, the two actuators working together.

If the piezoelectric material of both actuators 71 and 72 of the device of FIG. 4 are poled in the same manner, then the actuators 71 and 72 need to be driven in opposition during operation. Preferably however, one actuator 71 is poled in the opposite sense from the other actuator 72. The two actuators 71 and 72 can then be driven by the same electrical signal, preferably by just one and the same electronic driver amplifier.

A variant of the second variable focal length lens 40 of FIG. 4 is shown in FIG. 5. In this case, the transparent elastomeric membrane forming the interface 10 of the second variable focal length lens 40 is replaced by a transparent plate 102 with a surrounding elastomeric suspension 103 attached to the housing 9. The suspension 103 is an elastically deformable film (not necessarily transparent) which allows the plate 102 to displace in either direction, towards the second chamber 32 (as shown in FIG. 5) or towards the first chamber 31, according to the pressure applied to the liquids A or B. A perspective view of the plate 102 and suspension 103 is shown in FIG. 6. The optical power of the variant of FIG. 5 is somewhat less than that achievable with the arrangement of FIG. 4. However, the advantage of the variant of FIG. 5 is that the plate 102 may be manufactured in a material with higher optical quality than that available in transparent elastomeric films.

The transparent plate 102 of FIG. 5 is shown flat and parallel sided. It may instead have one or both surfaces curved, in a convex or concave manner. In the case where the plate 102 is a lens having a differing refractive index from the liquids 11 and 12, it is not absolutely necessary that the liquids 11 and 12 have differing refractive indices, since the movement of the lens 102 along the optic axis will itself result in changes in focus. Alternatively, the liquids 11 and 12 may have differing refractive indices and the lens 102 may have a refractive index either matched to one of the liquids 11 and 12 or differing from both the liquids 11 and 12.

FIGS. 7A and 7B are ray diagrams shoving how the focal length of the first or second variable focal length lens 1 or 40 change with curvature of the interface 10. In FIG. 7A, the interface 10 curves upwards slightly. In this example, liquid 12 has a higher refractive index than liquid 11. The lens 1 or 40 therefore forms a converging lens and parallel rays from infinity (at the bottom of FIG. 4) are brought to a focus at focal point f₁. In FIG. 7B, the interface 10 is curved to a greater degree, converging the rays to focal point f₂ which is closer to the lens 1 or 40 than the focal point f₁. The focal length of the lens 1 or 40 therefore varies with the extent of curvature of the interface 10, corresponding to the degree of activation of the actuator 7.

FIGS. 8A and 8B are ray diagrams similar to those of FIGS. 7A and 7B but with the modification that the window 3 is curved to a converging lens. In this case, parallel rays converge to a focal point f₃ even though the interface 10 between liquids 11 and 12 is flat (no activation of the actuator 7). FIG. 8B shows the interface 10 curving downwardly. The rays first converge at the window 3 and then diverge at the interface 10, bringing the rays to focus at focal point f₄, which is further from the device than the focal point f₃. Thus it is clear that the focal length of the lens 1 or 40 may be made to vary by changing the direction and degree of curvature of the interface 10, corresponding to the polarity and degree of activation of the actuator 7.

1. A variable focal length lens, comprising: a chamber arrangement containing two transparent liquids adjacent one another with an interface therebetween, the chamber arrangement allowing light to pass along an optical axis through the transparent liquids and across the interface, the lens focusing the passing light; a piezoelectric actuator arranged, on activation, to change the pressure of one of the liquids so that the interface moves to change the focal length of the lens.

2. A variable focal length lens according to claim 1, wherein the liquids have a differing refractive index and the piezoelectric actuator is arranged, on activation, to change the pressure of one of the liquids so that the interface moves by changing shape to change the focal length of the lens.

3. A variable focal length lens according to claim 2, wherein the liquids have substantially the same density.

4. A variable focal length lens according to claim 3, wherein the liquids are immiscible liquids touching one another.

5. A variable focal length lens according to claim 2, further comprising a transparent elastomeric membrane at the interface between the liquids.

6. A variable focal length lens according to claim 1, further comprising a rigid transparent element at the interface between the liquids, the piezoelectric actuator is arranged, on activation, to change the pressure of one of the liquids so that the rigid transparent element at the interface moves by being displaced along the optical axis to change the focal length of the lens.

7. A variable focal length lens according to claim 1, wherein the chamber arrangement includes a chamber containing one of the liquids, which chamber has a chamber wall extending around the optical axis made at least in part of a deformable elastic material, the piezoelectric actuator engaging the deformable elastic material.

8. A variable focal length lens according to claim 7, wherein the chamber wall is made of a deformable elastic material around its entire circumference and the piezoelectric actuator extends around substantially the entirety of the deformable elastic material.

9. A variable focal length lens according to claim 7, wherein the piezoelectric actuator is shaped as a section of a cylinder.

10. A variable focal length lens according to claim 9, wherein the piezoelectric actuator has a bender construction.

11. A variable focal length lens according to claim 1, having a single said piezoelectric actuator arranged, on activation, to change the pressure of a first one of the liquids

12. A variable focal length lens according to claim 11, wherein the chamber arrangement has pressure relief means for relieving pressure changes in the second one of the liquids.

13. A variable focal length lens according to claim 12, wherein the chamber arrangement includes a chamber containing the second one of the liquids, which chamber has a chamber wall extending around the optical axis made at least in part of a deformable elastic material which comprises said pressure relief means.

14. A variable focal length lens according to claim 1, having two said piezoelectric actuators each arranged, on activation, to change the pressure of a respective one of the liquids

15. A variable focal length lens according to claim 1, wherein the chamber arrangement contains further transparent liquids adjacent one of said two liquids with an interface therebetween, the chamber arrangement allowing light to pass along an optical axis through all transparent liquids and across all the interfaces.

16. A variable focal length lens according to claim 1, wherein the lens further comprises rigid lens elements arranged along the optical axis, the passing light being focused by the liquids and the rigid lens elements in combination.

17. A variable focal length lens according to claim 1, wherein the lens has a diameter of at least 1 mm.

18. A variable focal length lens according to claim 1, wherein the lens has a diameter of at most 20 mm.

19. A camera including a variable focal length lens according to claim 1.
